(19) United States
(12) Patent Application Publication
(10) Pub. No.: US 2012/0173879 A1
(43) Pub. Date: Jul. 5, 2012

(54) SECURE TRANSFER OF DATA USING A FILE TRANSFER APPLICATION OVER A USB TRANSPORT LAYER

(75) Inventors: Louis D. Bifano, Morrisville, PA (US); Santosh Basavaraj Budni, Bangalore (IN); Krishna Prasad Panje, Bangalore - Kamataka (IN); Somesh Saraf, Bangalore (IN)

(73) Assignee: GENERAL INSTRUMENT CORPORATION, Horsham, PA (US)

(21) Appl. No.: 12/980,432

(22) Filed: Dec. 29, 2010

(51) Int. Cl. G06F 13/10; H04L 9/00

(52) U.S. Cl. 713/182; 710/36

(57) ABSTRACT

A media device includes a memory for storing a file transfer application and a storage device for storing content. The device also includes at least one processor and an input-output (I/O) interface over which the file transfer application transfers content. The device also includes a protocol stack that is executable by the processor. The protocol stack includes a file transfer application layer, a transport protocol layer that does not include native support for security, and a security emulation layer located between the file transfer application layer and the transport protocol layer. The security emulation layer is executed in the transport protocol layer.

### BACKGROUND

Recently, communication protocols have developed for allowing a computing device to control and communicate with media devices such as digital cameras. One such protocol, the ISO 157540 Picture Transfer Protocol (PTP), can be used in connection with transferring images from imaging devices, such as cameras, to personal computing devices. This protocol defines how the digital still camera can communicate with a personal computing device. PTP has been extended so that many different types of content such as digital music and video can be easily presented, exchanged, processed, and reproduced. The extension to the PTP protocol is sometimes referred to as the Media Transport Protocol (MTP). For purposes herein the terms PTP and MTP will be used interchangeably.

The PTP protocol is an asymmetric control protocol, somewhat like a master/slave protocol. However, in PTP parlance one refers to the devices engaged in a picture transfer as the Initiator and Responder, rather than the Master and Slave. The Initiator device establishes and subsequently manages a control connection while the Responder is defined as the device that responds to operation requests such as an “OpenSession” request.

In the PTP protocol devices can be Initiators, Responders or both. For instance, a PC can be configured only as an Initiator device while a USB camera can be only a Responder. Similarly, a Bluetooth camera, that opens a connection to a Bluetooth/PTP printer and pushes pictures for print, can be only an Initiator while the corresponding printer can be only a Responder. However, a digital camera that can connect to other digital cameras and is able to both initiate and receive a PTP session is desired that is capable of behaving both as Initiator and Responder.

PTP is a transport independent protocol. In its original embodiment it was designed and intended for use over the Universal Serial Bus (USB) transport. However alternative transports can be readily implemented over local area networks. Examples include PTP over Bluetooth and PTP over IP networks (PTP/IP). However, due in part to its ease of use and wide availability, USB is often used as the transport protocol. When USB is employed, a digital camera, for example, can share a photo file with a personal computer (PC) using a USB cable to establish the connection between the camera and the PC. The photo file can then be transferred to PC over the USB cable using the picture transfer protocol (PTP).

### SUMMARY

In accordance with one aspect of the invention, a method and apparatus is provided for receiving content from a first media device. The method includes establishing a secure communication path using a universal serial bus (USB) protocol between the first media device and a second media device that is to receive the content. The content is received from the first media device over the secure communication path using a file transfer protocol.

In accordance with another aspect of the invention, a media device is provided. The media device includes a memory for storing a file transfer application and a storage device for storing content. The device also includes at least one processor and an input-output (I/O) interface over which the file transfer application transfers content. The device also includes a protocol stack that is executable by the processor. The protocol stack includes a file transfer application layer, a transport protocol layer that does not include native support for security, and a security emulation layer located between the file transfer application layer and the transport protocol layer. The security emulation layer is executed in the transport protocol layer.

In accordance with yet another aspect of the invention, a method is provided for implementing a communication protocol stack that includes a file transfer application layer, a transport protocol layer that does not include native support for security, and a security layer between the application and the transport layers. The method includes exchanging transport layer messages to transfer cryptographic information used to execute the security layer by the transport protocol layer. Content is caused to be transmitted or received over a communication path supporting the communication protocol stack. The cryptographic information that is exchanged includes information used to encrypt and decrypt the transfer of the content.

### BRIEF DESCRIPTION OF THE DRAWINGS

FIG. 1 shows an illustrative operating environment in which the methods, techniques and devices described herein may be employed.

FIG. 2 shows a logical diagram of two media devices which communicate over a USB Bus without security.

FIG. 3 shows a logical diagram of two media devices which communicate over a USB Bus in a secure manner using a SSL-emulated layer.

FIG. 4 shows a conventional USB transport state machine

FIG. 5 shows a USB transport state machine that emulates a security layer.

FIG. 6 shows one illustrative example of a message exchange process between a host and a media device that may be used to conduct an SSL-emulated handshake

FIG. 7 is a schematic block diagram illustrating one example of a media device that may serve as either a PTP initiator PTP responder or both a PTP initiator and responder.

### DETAILED DESCRIPTION

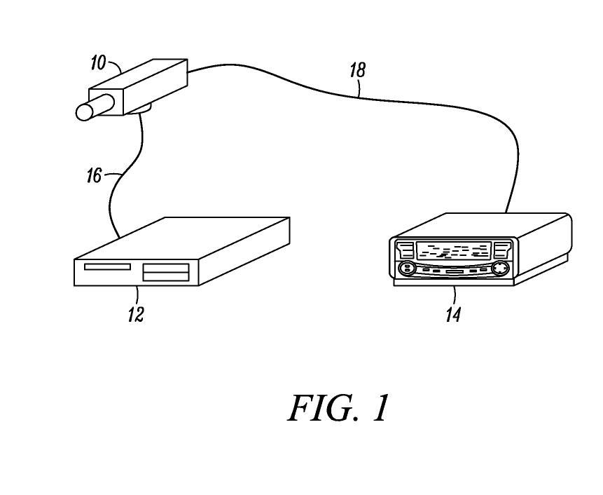

FIG. 1 shows an illustrative operating environment in which the methods, techniques and devices described herein may be employed. A video camera 10 is in communication with a set-top box 12 and a portable media player 14 over input/output (I/O) buses 16 and 18, respectively. Through the I/O bus 16 the video camera 10 can transmit video or other content or data to the set-top box 12 for storage therein and/or for immediate rendering on a display device such as a television. Likewise, through the I/O bus 18, the video camera 10 can transmit video content to the portable media player 14 for storage therein and/or for immediate rendering. Both the set-top box 12 and the portable media player 14 can also send video or other content or data to the set-top box 12 over I/O busses 16 and 18, respectively. Likewise, the set top box 12 can transmit content to the portable media player 14 over another I/O bus (not shown). More generally, video camera 10, set-top box 12 and portable media player 14 are representative of any media device that transmits or receives content or data over an I/O bus. Non-limiting examples of such media devices include video game consoles, PDAs, portable DVD and media players, cellphones, PCs, home stereo equipment (e.g., digital audio players), car stereos and portable memory devices. In one implementation the I/O busses are Universal Serial Busses (USB).

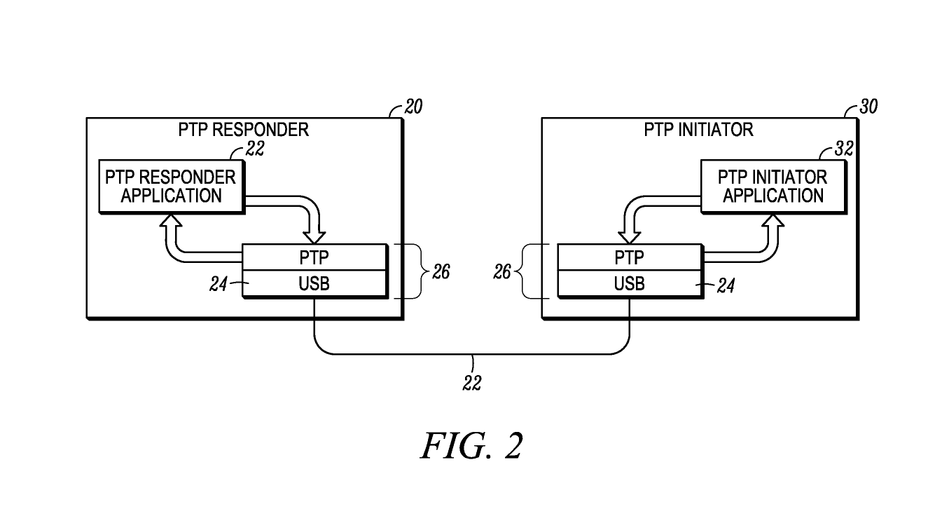

The media devices in FIG. 1 may communicate with one another and transfer content and other data using the Picture Transfer Protocol (PTP). FIG. 2 shows a logical diagram of two media devices 20 and 30 which communicate over a USB Bus 22. In some implementations media devices 20 and 30 may be any of the devices mentioned above in connection with FIG. 1. For purposes of illustration media device 30 will be treated as the PTP initiator which establishes and subsequently manages a control connection while media device 20 will be treated as the PTP responder that responds to operation requests from the Initiator 30. Depending on its capabilities, a device may serve as an initiator only, a responder only, or both an initiator and a responder.

Responder 20 includes a PTP responder application 22 and Initiator 30 includes a PTP initiator application 32. As shown, the PTP protocol employed by PTP applications 22 and 30 operates over the USB transport layer.

One deficiency with the USB protocol is its inability to establish a secure connection between devices. This can be a problem, for instance, when encrypted content is being transferred from one device to another. For example, if a user wishes to download encrypted content stored on a set-top box to a portable media player, the portable media player will need to receive both the encrypted content and the key or keys necessary to decrypt the content. In such a case it would be desirable to transfer the key or keys securely so that cannot be hacked or otherwise obtained by an unauthorized user. One way to overcome this problem is illustrated in the logical diagram of FIG. 2

As shown in FIG. 2, in order to establish a secure connection between PTP devices, a secure layer 210 can be provided between the PTP layer 200 and the USB layer 220. The secure layer 210 allows the PTP devices to share data in a secure manner. In one implementation the secure layer may be a secure sockets layer (SSL). SSL is a commonly-used protocol for managing the security of message transmission on the Internet. Other encryption technologies exist as well. For example, the Transport Layer Security (TLS) protocol, which is based on the SSL protocol, has recently emerged as a possible successor to the SSL protocol. The SSL protocol typically operates above TCP/IP and below higher-level protocols such as HTTP or IMAP. SSL can offer both authentication and privacy. In particular SSL allows an SSL-enabled server to authenticate itself to an SSL-enabled client, allows the client to authenticate itself to the server, and allows both machines to establish an encrypted connection to ensure privacy. SSL uses public-and-private key encryption, as well as digital certificates.

The SSL protocol uses a combination of public-key and symmetric key encryption. The SSL protocol includes an SSL handshake protocol to exchange a series of messages between an SSL-enabled server and an SSL-enabled client when they first establish an SSL connection. An SSL session begins with an exchange of messages called the SSL handshake. The SSL handshake allows the server to authenticate itself to the client using public-key techniques, then allows the client and the server to cooperate in the creation of symmetric keys used for encryption, decryption, and tamper detection during the ensuing SSL session. Optionally, the handshake also allows the client to authenticate itself to the server.

As previously mentioned, a PTP application operating over the USB protocol does not provide the ability to establish a secure connection between devices. One way to overcome this problem is by defining USB messages that emulate the SSL handshake. The USB protocol defines two types of messages, events and operation codes (“opcodes”). In USB one of the devices serves as the host. A host communicates data to a device using opcodes. A device communicates to a host using events. The USP protocol uses pre-defined events and opcodes to perform its functions. However, the USP specification also allows the use of vender-defined events and opcodes. In order to address the lack of security when USB is used as a transport protocol, such USB vender-defined events and opcodes may be used to emulate the SSL handshake. In other words, a security emulation layer can be executed in the transport protocol layer. The security emulation layer can offer privacy, authenticity, or both privacy and authenticity.

Once the SSL-emulated handshake has been completed a host and device will have established an encryption algorithm and exchanged cryptographic keys which can be used to encrypt and decrypt data during the data-exchange phase of a PTP transaction. The vocabulary of vendor-defined USB events and opcodes which are used to emulate the SSL handshake may be defined in any desired manner.

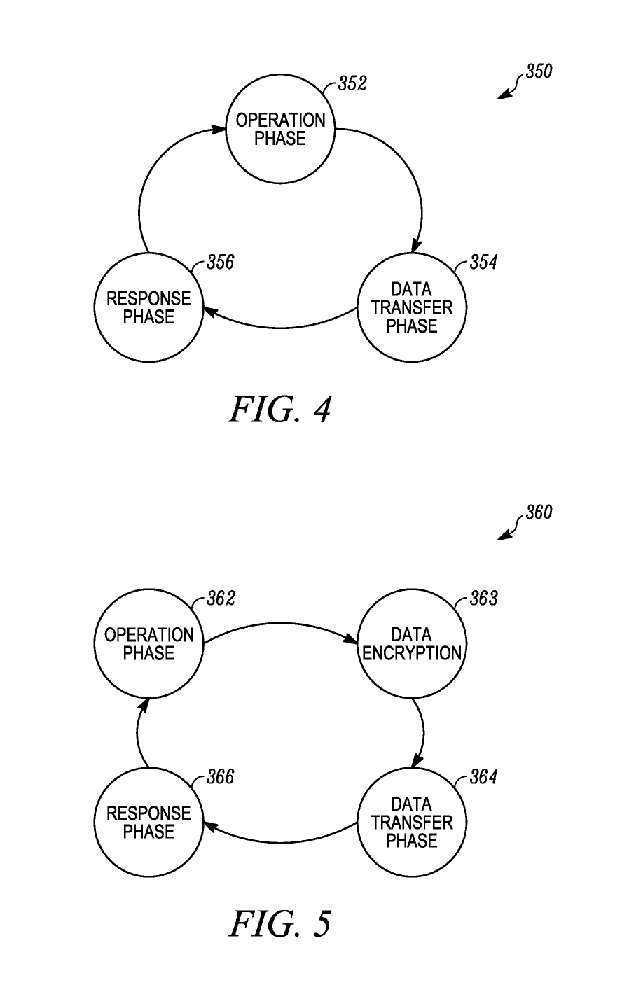

FIG. 4 shows the conventional USB transport state machine 350. As shown, there are three main phases: command 352, data transfer 354 and response 356. The host initiates the command phase 352 by sending a command to the media device and also sends data in the data transfer phase by encapsulating the data in containers. Finally, the media device sends a response indicating the result of the command in the response phase 356.

FIG. 5 shows a USB transport state machine 360 that emulates a security layer. Similar to the state machine 350 shown in FIG. 4, the state machine 360 includes a command phase 362, a data transfer phase 364 and a response phase 366. The state machine 360 also includes a data encryption phase 363 after the operation phase 362 but before the data transfer phase 364. The SSL-emulated handshake is performed during the data encryption phase 363.

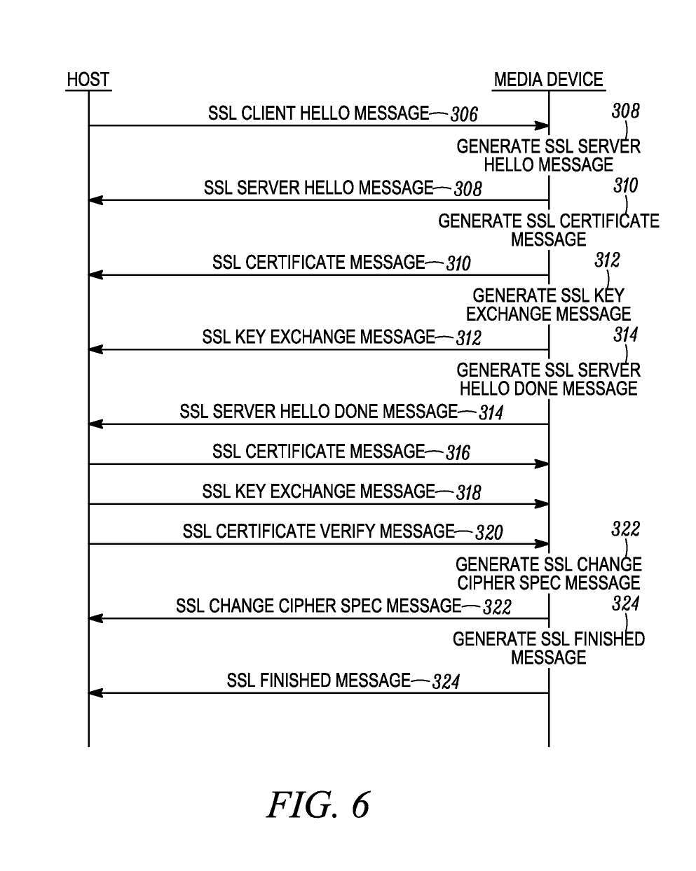

One illustrative example of the message exchange process between a host and device that may be used to conduct the SSL-emulated handshake is shown in FIG. 6. In this example the host (e.g., a set-top box) acts as the PTP initiator and the device (e.g., a portable media player) acts a PTP responder. Accordingly, the host acts as the master and the device acts as the slave. The device will therefore use events to indicate to the host when it requires an operation by the host and the host will respond with an opcode.

It should be noted that the details of this message exchange process will depend on the how the USB events and opcodes are defined. Accordingly, the message exchange process shown in FIG. 6 is presented for illustrative purposes only and should not be construed as limiting in any way. Moreover, the data included in the messages described above, as well as those discussed below, may be combined into a fewer number of messages or, in some cases, divided among a greater number of message.

The SLL handshake emulation process 300 begins when the host sends a message 302 (e.g., an opcode) to the device to start the SSL session and a message 304 to initialize the SSL library, which may be a conventional SSL library. The host also sends a SSLClientHello message 306 to the device. The SSL ClientHello message 306 defines the capabilities of the host, which will be subsequently used by the device to agree upon a set of algorithms to use for privacy and security. In response to the SSLClientHello message 306, the device generates an SSLServerHello message 308 to the host, which defines the capabilities of the device. The host then pulls the SSLServerHello message 308 from the device.

Once the hello phase of the SSL-emulated handshake process is complete, a device authentication phase begins. In this example the authentication phase begins when the device generates an SSLCertificate message 310 containing the device's digital certificate. The host then pulls the SSLCertificate message 310 from the device.

In a key exchange phase, the device generates an SSLKeyExchange message 312 which is subsequently pulled by the host. The content of the SSLKeyExchange message 312 will depend on the public key algorithm selected as a result of the SSL ClientHello and SSLServerHello messages, but will generally include a pre-master key.

The device next generates a SSLServerHelloDone message 314, indicating that the hello-message phase of the handshake is complete. Once again, the SSLServerHelloDone message 314 is pulled by the host. The host then pushes SSLCertificate 316 message to the device to perform host authentication. The host also sends to the device a SSLKeyExchange 318 message with its pre-master key and a SSLCertificateVerify 320 message.

A SSLChangeCipherSpec message 322 is generated by the device in order to tell the host to establish the agreed-upon security settings (i.e., the cipher suite) and the message 322 is pulled by the host. Finally, the device generates an SSLFinished message 325 that is pulled by the host. At this point, the handshake is complete and the client and server may begin to exchange application layer data in a secure manner.

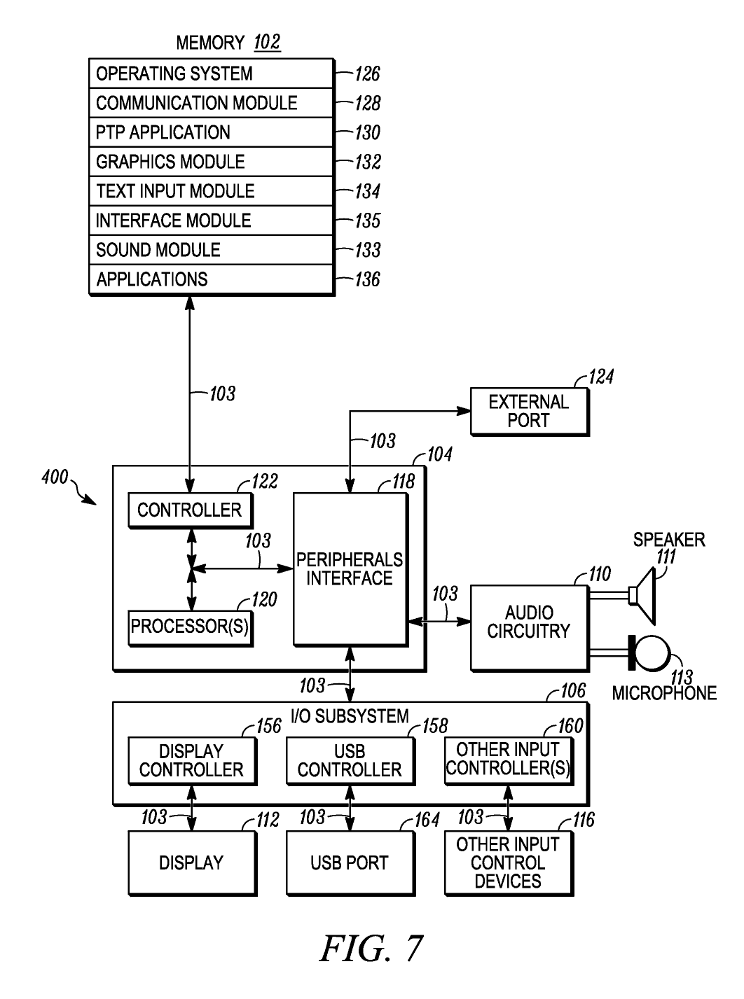

FIG. 7 is a schematic block diagram illustrating one example of a media device 400 that may serve as either a PTP initiator PTP responder or both a PTP initiator and responder. Device 400 may be any of the devices discussed in connection with FIG. 1 or any other device that can implement a file transfer application such as PTP. The device 400 includes a memory 102 (which may include one or more computer readable storage media), a memory controller 122, one or more processors (CPU's) 120, a peripherals interface 118, audio circuitry 110, a speaker 111, a microphone 113, an input/output (I/O) subsystem 106, and other input or control devices 116. These components may communicate over one or more communication buses or signal lines 103.

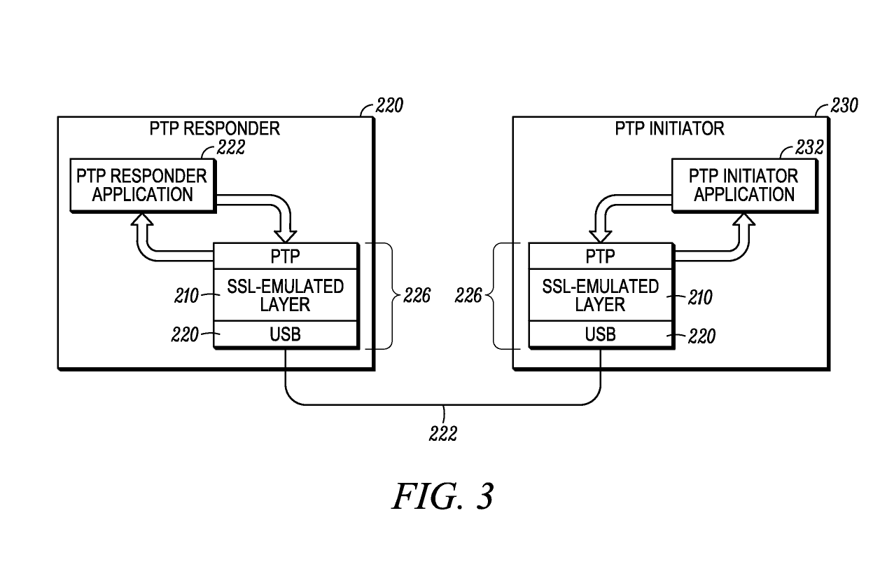

Memory 102 may include high-speed random access memory and non-volatile memory, such as one or more magnetic disk storage devices, flash memory devices, or other non-volatile solid-state memory devices. Access to memory 102 by other components of the device 100, such as the CPU 120 and the peripherals interface 118, may be controlled by the memory controller 122. The peripherals interface 118 couples the input and output peripherals of the device to the processor 120 and memory 102. The one or more processors 120 run or execute various software programs and/or sets of instructions stored in memory 102 to perform various functions for the device 100 and to process data. In particular, the one or more processors 120 may implement the PTP protocol stack shown in FIG. 3, portions of which may be embodied in software residing in memory 102 and other portions of which may reside in USB controller 158 (discussed below). In some examples the peripherals interface 118, the CPU 120, and the memory controller 122 may be implemented on a single chip, such as a chip 104. In other examples they may be implemented on separate chips.

The I/O subsystem 106 couples input/output peripherals on the device 100, such as the display 112 and other input/control devices 116, to the peripherals interface 118. The I/O subsystem 106 may include a USB controller 158 for handling data received by a USB port 164. The I/O subsystem 106 may couple other I/O peripherals such as a display controller 156 and display 112 and one or more input controllers 160 for other input or control devices 116. The other input/control devices 116 may include a keyboard, physical buttons (e.g., push buttons, rocker buttons, etc.), dials, slider switches, joysticks, click wheels, a pointer device such as a mouse and so forth.

In some embodiments, the software components stored in memory 102 may include an operating system 126, a communication module (or set of instructions) 128, a graphics module (or set of instructions) 132, a text input module (or set of instructions) 134, a sound module 133 (or set of instructions) a PTP or other file transfer application 131 (or set of instructions) as well as other applications (or set of instructions) 136.

The operating system 126 (e.g., Darwin, RTXC, LINUX, UNIX, OS X, Microsoft WINDOWS, Android or an embedded operating system such as VxWorks) includes various software components and/or drivers for controlling and managing general system tasks (e.g., memory management, storage device control, power management, etc.) and facilitates communication between various hardware and software components. In some implementations the other applications 136 may include any combination of the following modules: a contacts module, a telephone module; a video conferencing module; an e-mail client module an instant messaging (IM) module; a blogging module; a camera module; an image management module; a video player module; a music player module; a browser module; a word processing module; a voice recognition module; a calendar module; widget modules, which may include a weather widget, stocks widget, calculator widget, alarm clock widget, dictionary widget, and other widgets obtained by the user, as well as user-created widgets.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. In some embodiments, memory 102 may store a subset of the modules and data structures identified above. Furthermore, memory 102 may store additional modules and data structures not described above. In some implementations one or more the software components such as the PTP file transfer application 136 may be incorporated into the operating system 126.

It should be appreciated that the media device 400 is only one example of a media device and that the device 400 may have more or fewer components than shown, may combine two or more components, or a may have a different configuration or arrangement of components. For instance, if the media device 400 is a digital camera, or incorporates a digital camera, the device 400 will include an optical sensor such as a charge-coupled device (CCD) or a complementary metal-oxide semiconductor (CMOS) phototransistor. Alternatively, if the media device 400 is or includes the functionality of a wireless phone, the device 400 will include RF (radio frequency) circuitry to communicate using any of a variety of communication standards including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS)). The various components shown in FIG. 3 may be implemented in hardware, software or a combination of both hardware and software, including one or more signal processing and/or application specific integrated circuits.

Although various embodiments are specifically illustrated and described herein, it will be appreciated that modifications and variations of the present invention are covered by the above teachings and are within the purview of the appended claims without departing from the spirit and intended scope of the invention. For example, while the invention has been described in the context of a PTP protocol operating on a USB transport protocol, the invention is also applicable to other file transfer protocols and applications and other transport protocols that do not include native support for security.

1. A method for receiving content from a first media device, comprising:
establishing a secure communication path using a universal serial bus (USB) protocol between the first media device and a second media device that is to receive the content; and
receiving the content from the first media device over the secure communication path using a file transfer protocol.

2. The method of claim 1 wherein the secure USB communication path is configured to employ the USB protocol to emulate a secure protocol.

3. The method of claim 2 wherein the USB protocol emulates the secure protocol using vendor-definable USB messages.

4. The method of claim 3 wherein the USB messages include vendor-definable USB events and USB operational codes.

5. The method of claim 2 wherein the secure protocol being emulated is a Secure Sockets Layer (SSL) protocol.

6. The method of claim 1 wherein the file transfer protocol is a Picture Transfer Protocol (PTP).

7. The method of claim 2 wherein the content is encrypted and further comprising receiving a cryptographic key during a handshake phase of the secure protocol being emulated.

8. The method of claim 2 wherein the secure protocol being emulated supports both privacy and authentication.

9. A media device, comprising:
a memory for storing a file transfer application;
a storage device for storing content;
an input-output (I/O) interface over which the file transfer application transfers content;
at least one processor; and
a protocol stack executable by the processor, said protocol stack including a file transfer application layer, a transport protocol layer that does not include native support for security, and a security emulation layer located between the file transfer application layer and the transport protocol layer, said security emulation layer being executed in the transport protocol layer.

10. The media device of claim 9 wherein the file transfer application employs a file transport protocol that is transport independent.

11. The media device of claim 10 wherein the transport protocol layer conforms to a USB protocol.

12. The media device of claim 11 wherein the USB protocol emulates the secure protocol using vendor-definable USB messages.

13. The media device of claim 12 wherein the USB messages include USB events and USB operational codes.

14. The media device of claim 10 wherein the secure protocol being emulated is a Secure Sockets Layer (SSL) protocol.

15. The media device of claim 9 wherein the file transfer protocol is a Picture Transfer Protocol (PTP).

16. The media device of claim 9 wherein the secure emulation layer supports both privacy and/or authentication.

17. A computer-readable storage medium encoded with computer-executable instructions for implementing a communication protocol stack that includes a file transfer application layer, a transport protocol layer that does not include native support for security, and a security layer between the application and the transport layers, the instructions comprising:
exchanging transport layer messages to transfer cryptographic information used to execute the security layer by the transport protocol layer; and
causing content to be transmitted or received over a communication path supporting the communication protocol stack, wherein the cryptographic information that is exchanged includes information used to encrypt and decrypt the transfer of the content.

18. The computer-readable storage medium of claim 17 wherein the transport layer messages emulates the SSL protocol.

19. The computer-readable storage medium of claim 18 wherein the transport layer messages include vendor-definable transport layer messages.

20. The computer-readable storage medium of claim 19 wherein the transport layer protocol is USB and the vendor-definable transport layer messages include USB events and USP operational codes.
